(19) United States
(12) Patent Application Publication
(10) Pub. No.: US 2024/0124012 A1
(43) Pub. Date: Apr. 18, 2024

(54) Method, Device and Storage Medium for Scheduling Notification Based on Driving assistance features

(71) Applicant: JINAN ZHENZHEN TECHNOLOGY RESEARCH INSTITUTE, Jinan (CN)

(72) Inventor: Tingting ZHAO, Beijing (CN)

(73) Assignee: JINAN ZHENZHEN TECHNOLOGY RESEARCH INSTITUTE, Jinan (CN)

(21) Appl. No.: 18/541,942

(22) Filed: Dec. 15, 2023

Related U.S. Application Data
(63) Continuation of application No. PCT/CN2022/115336, filed on Aug. 28, 2022.

(30) Foreign Application Priority Data
Aug. 28, 2021 (CN) 202110999360.7

(51) Int. Cl. B60W 50/14; G07C 5/00

(52) U.S. Cl. CPC B60W 50/14; G07C 5/008; B60W 2050/146

(57) ABSTRACT

A method, device and storage medium for scheduling notification based on driving assistance features. The method comprises determining a status of at least one driving assistance feature of the vehicle and scheduling notification of a user by a message on the electronic device based on the status of the at least one driving assistance feature.

### CROSS-REFERENCE TO RELATED APPLICATIONS

This application is a continuation application of International Application No. PCT/CN2022/115336 filed Aug. 28, 2022 which claims the priory to CN202110999360.7 filed Aug. 28, 2021, the disclosures of which are incorporated herein by reference in their entireties.

### TECHNICAL FIELD

The present disclosure relates to scheduling notifications based on driving assistance features, particularly to scheduling the notifications on the devices in vehicles.

### BACKGROUND

For human drivers, there is a risk of dangerous incidents arising from answering phone calls or viewing messages on client devices. Some messages may be ones that users expect to receive immediately, for example, messages for work or messages from family members. However, there are also various messages, such as advertisements pushed by shopping APPs, tips pushed by social medias, etc., which users may not expect to immediately receive.

Several technologies have been developed aimed at reducing the negative impact on drivers caused by incoming phone calls or messages.

For example, “ARIYAMA YOSHIHIRO” et al. developed a technology published by JP Patent Application numbered JPH114190A: determining whether the car is running based on, for example, a control unit of the vehicle engine, and blocking incoming calls from sounding or lowering its volume if a call is received while the vehicle is running.

For example, “ANIL KUMAR PANDURANGARAO” et al. developed a technology published by US Patent Application numbered US2018/0097928A1: determining whether to allow the receiving of incoming phone events based on vehicle operation data, environmental condition data, incoming phone event data, user authorization preference data, driver scoring data and risk map data and so on.

These techniques generally schedule messages based on the vehicle's operating status or operating environment.

### SUMMARY OF THE INVENTION

Various aspects according to the present disclosure allow notification of messages to be scheduled based on the status of a vehicle's driving assistance features. Scheduling of messages in accordance with aspects of the present disclosure may allow message notifications to a user to be scheduled independently of one or more of vehicle operating status, operating parameters, and/or the vehicle's surrounding environment.

According to the prior arts, the scheduling of notifications is based on conditions such as vehicle operating status, operating parameters and/or the vehicle's surrounding environment. However, as technology develops, especially driving assistance technologies mature rapidly, these solutions are no longer reasonable. Because, when using driving assistance features, these conditions do not reflect the degree to which the driver is busy for driving. For example, when the vehicle is driving in a more complex traffic environment or at a faster speed, the user can activate the driving assistance feature or activate a higher-level driving assistance feature. In this case, it is reasonable to notify the user of more messages, as the driver is not required to concentrate more on operating the vehicle, even if the traffic environment is worse. In the opposite case, if the driving assistance feature is deactivated or switched from a higher to a lower level of driving assistance feature and the user is therefore required to participate at least partially in the operation of the vehicle, then it would be unreasonable to inform users of the messages even if the vehicle's operating environment becomes less risky. Therefore, aspects of the present disclosure may allow scheduling of notifications to be determined based on the user's (driver's) workload of operating the vehicle rather than based on how busy the traffic is. Therefore, an advantage of at least some examples of various aspects of the present disclosure is to improve security in a more reasonable manner.

At least some of the examples of the present disclosure is that obtaining input parameters is less costly. Driving assistance features may be integrated designed and standardized functions. Compared with the solutions that obtaining input parameter, for example, from end components (such as wheel speed, throttle opening as described in the prior art) as an input parameter, using information indicating the activation of driving assistance features obtained from a driving assistance system is a more simple manner where various overheads (such as signal measurement costs, data processing costs, communication protocol costs, etc.) can be very low.

At least some of the examples of the present disclosure is that users can acknowledge that messages may be scheduled (e.g., blocked or delayed) avoid messages being scheduled without their knowledge. This is because the scheduling of the change of notification rule may be generally based on the activation of the driving assistance features and/or the switching among the driving assistance features, so the user can expect that the notification of the message will be scheduled when operating with the driving assistance features. In other words, various aspects of the present disclosure allow the user to achieve both switching of the driving assistance feature and the change among the message notification modes through a single operation (switching the driving assistance feature).

An aspect of the present disclosure provides a portable electronic device that may comprise a communication module which is able to communicatively coupled to a vehicle and receive, from the vehicle, an information associated with a status of at least one driving assistance feature of the vehicle. The portable electronic device comprises a processor that configured to being able to schedule a notification to a user of a message on the portable electronic device based on the status of the at least one driving assistance feature of the vehicle.

Another aspect of the present disclosure provides human-computer interaction device for installation on a vehicle, comprising: a memory to store instructions; a processor configured to, when executing the instructions, enable the human-computer interaction device to: determine the status of at least one driving assistance feature of the vehicle; and schedule the notification of a message to a user on the human-computer interaction device based on the status of the at least one driving assistance feature of the vehicle.

Another aspect of the present disclosure provides a vehicle, which comprises the human-computer interaction device according to the present disclosure.

Another aspect of the present disclosure provides a server device configured to: communicatively coupled to a vehicle via a network and obtain from the vehicle, an information indicating a status of at least one driving assistance feature of a vehicle; and scheduling the notification of the message to be sent to the vehicle based on the status of the at least one driving assistance feature of the vehicle.

Another aspect of the present disclosure provides a method comprising: determining a status of at least one driving assistance feature of a vehicle; and scheduling a notification to a user of a message on the portable electronic device based on the status of the at least one driving assistance feature.

Another aspect of the present disclosure provides a non-transitory machine-readable storage medium storing instructions that, when executed by a processor, cause the processor to perform the method according to the present application.

According to various aspects of the present disclosure, the device's screen may not be turned off (allowing the device's screen to remain on or lighted) when scheduling the notification of the message to the user. Therefore, compared with the existing technology that prevents the user from receiving messages by closing the device screen, the device of the present disclosure can prevent users from passively attracting attention to message events while allow the user to voluntarily use the functions of the device (for example, interacting with APPs by touching the device) in any condition that the driving assistance features are turned on or off. Therefore, it is possible to provide security improvements without degrading the user experience. For example, users will not be prevented from voluntarily using functions on the device, and necessary information (such as navigation, etc.) will not be blocked.

According to various aspects of the present disclosure, a trigger mechanism for receiving a trigger from a user to change the state of the at least one driving assistance feature may interpret different trigger gestures from the user. Different trigger gestures may correspond to different scheduling modes for scheduling the notifications of messages to user. Therefore, a schedule selection feature for the user to select a desired scheduling mode from different scheduling modes can be provided on a same trigger mechanism. Therefore, when the user operates the trigger mechanism to change the state of the at least one driving assistance feature, the user can, in passing, select a desired message notification scheduling mode, for example, whether to block message notifications or not to block message notifications after quitting from a specific driving assistance feature.

Those skilled in the art will understand that the above advantages are merely exemplary. The above-mentioned advantages are only part of the significant progress of the technical solution claimed in this disclosure over the prior art, and are not intended to limit the scope of the technical solution to be protected by the present application.

### BRIEF DESCRIPTION OF THE DRAWINGS

Illustrative examples will now be described with reference to the accompanying drawings, which are schematic and not necessarily to scale, in which:

FIGS. 1A and 1B are schematic diagrams illustrating a portable electronic device according to an example of the present disclosure;

FIG. 2 is a schematic diagram illustrating a human-computer interaction device according to an example of the present disclosure;

FIG. 3 is a schematic diagram illustrating a server device according to an example of the present disclosure;

FIG. 4 is a schematic diagram illustrating a method according to an example of the present disclosure; and

FIG. 5 is a schematic diagram illustrating a machine-readable storage medium according to an example of the present disclosure.

### DETAILED DESCRIPTION

Vehicles may be configured with a variety of different levels of driving assistance features. For example, some driving assistance features may allow vehicles to accelerate/or decelerate based on the acceleration/deceleration of a preceding vehicle, thereby allowing the driver to not need to manually operate speed control mechanisms such as acceleration and/or deceleration pedals. For example, some driving assistance features may further allow the vehicle to automatically change the driving direction according to the geometric characteristics of the road (e.g., lanes), thereby further free the driver from manually operating the directional control mechanism such as the steering wheel. For example, some driving assistance features may allow a vehicle to travel at least partially autonomously on an enclosed road (e.g., a highway) without manual intervention by a driver. For example, some driving assistance features may further allow the vehicle to travel at least partially autonomously on open streets (where the vehicles and cyclists and/or pedestrians are not separated) without manual intervention by a driver. The “driving assistance features” disclosed herein comprises, but are not limited to, one or more of the above-mentioned auxiliary driving functions.

The above driving assistance features may be implemented by means of driving assistance systems. A driving assistance system may collect information associated with the vehicle's environment through sensors and can process the collected information to determine driving actions that can be taken. The driving assistance system may be coupled to components that control the movement of the vehicle (e.g., braking components, steering components, driveline components, etc.) and thus to control the movement of the vehicle.

Various examples in accordance with the present disclosure may schedule the notification of messages to a user on an electronic device based on the status of the at least one driving assistance feature.

For example, driving assistance system of the vehicle may be communicatively coupled, and information associated with the status of the driving assistance feature may therefore be obtained from the driving assistance system of the vehicle. The information associated with the status of the driving assistance feature may indicate whether the driving assistance feature is activated, deactivated, or which driving assistance feature among a plurality of different categories (or levels) of driving assistance features is activated or deactivated. The information associated with the status of the driving assistance feature may be used to determine the scheduling of information and/or information notifications.

The electronic device of the present disclosure may be a portable electronic device.

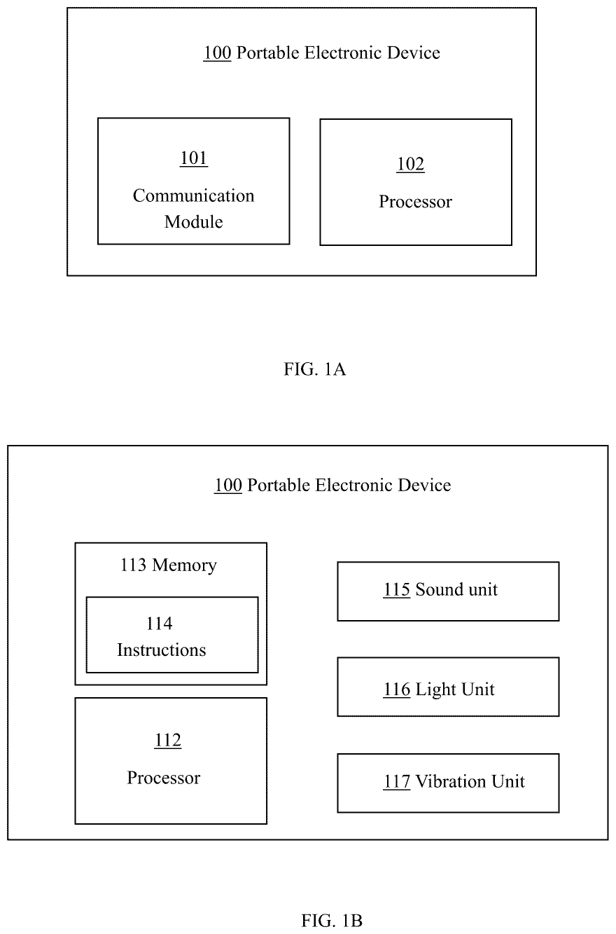

FIGS. 1A and 1B are schematic diagrams illustrating a portable electronic device 100 according to an example of the present disclosure. The portable electronic device 100 may be an electronic device capable of executing application programs (APP) and sending messages or notifications to a user, such as smartphone, tablet, laptop, wearable electronic device, and the like.

As shown in FIG. 1A, the portable electronic device 100 may comprises a communication module 101 which is able to communicatively coupled to a vehicle and to receive from the vehicle, information associated with a status of at least one driving assistance feature of the vehicle. For example, the vehicle may be equipped with an assisted driving system 100′ which may be configured to provide the information associated with the status of at least one assisted driving function. The communication module 101 can communicate with the assisted driving system 100′ and obtain the information associated with the status of at least one assisted driving function. The portable electronic device 100 may comprise a processor 102 which may process the obtained information associated with the status of the at least one assisted driving function and schedule the messages on the portable electronic device 100 based on the status of the at least one assisted driving function, or schedule the message notification to the user.

The “notification” herein may correspond to one or more of sound, light and vibration, the “light” may refer to content (such as icons, animations) displayed through a display screen composed of array of light-emitting elements, which may have a specific shape and/or size. Furthermore, the light may simply correspond to the light emitted by an indicating light, which may be monochromatic or polychromatic, and may not be the light displayed by the display screen.

The “message” herein may be a message generated locally by the device (or, in other words, a non-incoming message). For example, in an example of a portable electronic device, the message is a message related to the state of the device itself, such as the state of charge SOC. In an example of a human-machine interaction device on a vehicle, the message may also be a message related to the status of the vehicle (e.g., the SOC of the electric vehicle).

The “message” herein may be an incoming message to the device, for example, a message sent to the host device from another device or from an object external to the device, such as or a server. For example, the message may be a message notified to the user via an application executing on the device, such as chat content transmitted via a social application, advertisements pushed via a shopping APP, and so on. Messages may be incoming messages via a network such as a cellular network, such as phone calls and text messages, etc.

FIG. 1B shows an example of a portable electronic device 110. As shown in FIG. 1B, the portable electronic device 110 at least comprises a processor 112 and a memory 113 storing instructions 114. In an example, the portable electronic device 110 may further comprises one or more of a sound unit 115, a light unit 116, and a vibration unit 117 communicatively coupled to the processor 112, which may be controlled by the processor 112 to generate sound, light, and vibration that may cause the user's attention. The processor 112 may schedule the operations of the sound unit 115, light unit 116 and vibration unit 117 based on the obtained status of at least one driving assistance feature of the vehicle when executing the instructions 114 stored on the memory 113.

It should be noted that the various elements/components/units of the present disclosure are not necessarily only used to implement the embodiments of the present disclosure. For example, the processor 112, memory 113, etc. of the portable electronic device 110 may be shared with other functions of the electronic device.

In an example, portable electronic device 110 may comprises a scheduling mode. The portable electronic device 110 may schedule the notification of messages based on the status of the at least one driving assistance feature of the vehicle during the activation of scheduling mode, and may not schedule the notification of messages based on the status of the at least one driving assistance feature of the vehicle during the deactivation of the scheduling mode.

Accordingly, it is understood that “scheduling mode” herein may refer to a mode that provides a selection of whether to schedule notification of messages based on the status of at least one driving assistance feature of the vehicle. If the device is selected to perform “scheduling mode”, when message event occurs, the status of the at least one driving assistance feature shall be considered for sending the notification of the message to the user.

In an example, the portable electronic device 110 may have a human-computer interaction interface that allows the user to activate and/or deactivate the scheduling mode. For example, the portable electronic device 110 may be configured to comprises an option related to “notifications”. The options related to notifications may allow the user to configure how the device sends notifications to the user. In one embodiment, the option related to “notification” may be set to comprises options related to scheduling mode.

Those skilled in the art will understand that the options related to the scheduling mode do not necessarily need to be named as the “scheduling mode”, but they can be named in any way. The option should be understood to be equivalent to “scheduling mode” herein so long as it is configured so that when activated the portable electronic device 110 can schedule the notification of messages based on the status of at least one driving assistance feature of the vehicle.

In an example, the portable electronic device 110 may, in response to the deactivation of the scheduling mode, notify the user of messages that were not notified to the user during the activation of the scheduling mode. For example, when the user deactivates the scheduling mode via the device's human-computer interaction interface (e.g., through options related to the device's scheduling mode), the scheduled notification of the message (e.g., one or more of the blocked light, sound and the vibrations) may be released.

In an example, the portable electronic device 110 may activate the scheduling mode in response to detecting that the portable electronic device 110 is communicatively coupled to the vehicle. For example, the portable electronic device 110 may be configured to detect whether its communication module is connected to a communication module on the vehicle. If so, the portable electronic device 110 may activates its scheduling mode. The connection between the communication module of the portable electronic device 110 and the communication module on the vehicle may comprises one or more of the wireless connection (e.g., Bluetooth® connection, WiFi connection, Zigbee connection) and wired connection (such as USB 2.0, USB 3.0 or USB-C connection).

In an example, the portable electronic device 110 may deactivate the scheduling mode in response to a communication module of portable electronic device 110 being communicatively decoupled from the communication module of the vehicle. For example, the scheduling mode may be canceled when it is detected that the coupling between the communication module of the portable electronic device 110 and the communication module of the vehicle has been disconnected.

In an example, the portable electronic device 110 may also comprising a driving mode that provide specific configurations. For example, in this driving mode, the portable electronic device 110 may interact with an electronic device on board a vehicle and allow the electronic device on board the vehicle to access resources on the portable electronic device. For example, in this driving mode, the portable electronic device 110 may map its screen onto the screen of a human-computer interaction system on the vehicle. For example, in this driving mode, applications running on the portable electronic device may be operated via a human-computer interaction system on the vehicle. For example, this driving mode may be provided on a portable electronic device in a manner similar to other mode, for example, “flying mode”, “do not disturb mode”, “sleep mode” and the like, which have been developed are well familiar to the users. The driving mode can be displayed in the user operation interface of the electronic device together with these developed operating modes for selection by the user.

In an example, the scheduling mode of the device may correspond to the driving mode described above. Or say the scheduling mode may be activated in response to activation of the driving mode, and/or deactivated in response to deactivation of the driving mode.

According to the present disclosure, different types of notifications may be scheduled for different messages.

In an example, APPs can be classified and different types of notifications can be scheduled for messages from different APPs. For example, an instant messaging APP may be classified as a first category, while some applications such as a shopping APP may be classified into a higher second category. In a particular driving assistance feature status, a lower level of message scheduling can be made for the first category of applications, and a higher level of message scheduling can be made for the second category of applications.

In an example, different types of notifications can be scheduled for different types of messages from the same application. For example, for a specific APP, a lower-level notifications scheduling may be made for instant messaging messages in the APP, while higher-level notifications scheduling may be made for some messages in the APP such as advertisements and event reminders.

For example, the development architecture of the APP can be subject to the development architecture of the device manufacturer or device operating system provider. The device manufacturer or device operating system provider may require, via protocol, an APP, which attempt to access the APP associated with the elements of the device that associated with notifications, to provide an indication associated with the type of message and/or APP.

Table 1 below schematically illustrates eight different types of notifications.

TABLE 1

| proiect | produce light? | produce sound? | produce vibration? |
|---|---|---|---|
| 1^{st} notification | no | no | no |
| 2^{nd} notification | yes | no | no |
| 3^{rd} notification | no | yes | no |
| 4^{th} notification | no | no | yes |
| 5^{th} notification | yes | yes | no |
| 6^{th} notification | no | yes | yes |
| 7^{th} notification | yes | no | yes |
| 8^{th} notification | yes | yes | yes |

In Table 1, the 1st notification does not produce any of light, sound and vibration to the user. That is, the 1st notification does not attempt to attract the user's attention at all. Therefore, the 1st notification may also be referred to as the “first level scheduling”, that is, the highest-level scheduling. The 2nd to 4th notifications may present one of the light, sound and vibration to the user, and thus may be called “second level scheduling”. The 5th to 7th notifications may present two of light, sound and vibration to the user, and thus may be called “third level scheduling.” The 8th notification may present all of light, sound and vibration to the user, and may be referred to as a “fourth level of scheduling” or, alternatively, as no scheduling, or “0” scheduling.

It should be noted that the different levels of notifications shown above are only exemplary and are not intended to be exhaustive of all types or levels of notification scheduling. Different levels of notifications can also differ in any way as long as there is a gap in their effectiveness in getting the user's attention. For example, a lower level of notification scheduling may produce a louder sound than a higher level of notification. For example, a lower level of notification scheduling may produce a larger area or higher brightness display content than a higher level of notification.

Accordingly, the scheduling of notifications may indicate changes on the notification for a particular message or selection of notifications from among multiple notifications for a particular message.

The device of the present disclosure may be a human-computer interaction device on a vehicle.

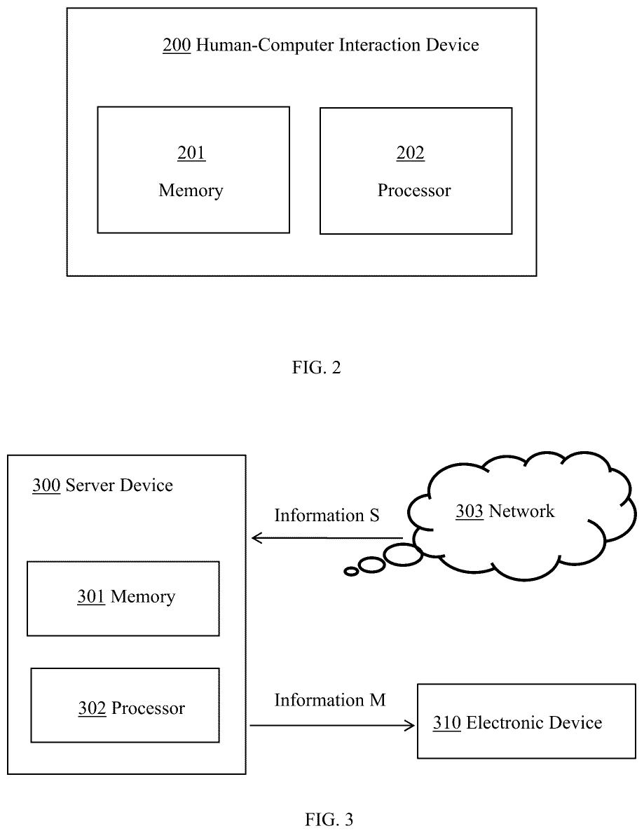

FIG. 2 is a schematic diagram illustrating a human-computer interaction device 200 according to an example of the present disclosure. The human-computer interaction device 200 may be an electronic device installed on the dashboard of the vehicle and may be used to provide features such as entertainment and vehicle function settings. The human-machine interaction device 200 is capable of scheduling notification of messages to the user on the human-machine interaction device based on the status of the at least one driving assistance feature of the vehicle.

As shown in FIG. 2, the human-computer interaction device 200 comprises a memory 201 and a processor 202. The memory 201 may store instructions that, when executed by the processor 202, enable the human-machine interaction device 200 to determine the state of the at least one driving assistance feature of the vehicle and to schedule the notifications of messages to the user on the human-computer interaction device based on the state of the at least one driving assistance feature of the vehicle.

For example, the human-machine interaction device 200 may be coupled to a component equipped with the vehicle associated with driving assistance and may obtain information associated with the status of the at least one driving assistance feature. Therefore, the human-computer interaction device 200 is able to determine the status of the at least one driving assistance feature.

In an example, the human-computer interaction device 200 may be independent from the component associated with driving assistance (e.g., a driving assistance system), and obtain an indication indicating the status of the at least one driving assistance feature directly from the component associated with driving assistance. Depending on this indication, the notifications of the message to the user are scheduled on the human-computer interaction device. Accordingly, examples of the present disclosure may provide a system to a user capable of scheduling messages on the human-computer interaction device 200. The system comprises: a driving assistance module configured to provide driving assistance features and capable of providing an indication of the status of at least one driving assistance feature; an interface module; and a human-computer interaction module configured to receive the indication of the status of the at least one driving assistance feature, via the interface module, from the driving assistance module and to schedule the notifications of the message to the user based on the indication.

In an example, the human-computer interaction device 200 may share elements with components associated with driving assistance. For example, the human-computer interaction device 200 may share the same processor with the driving assistance system, and the shared processor may perform operations associated with the driving assistance feature.

In an example, the human-computer interaction device 200 may be configured to determine a state of at least one driving assistance feature based on information associated with the driving assistance feature and to schedule the notification of the message to the user on the human-computer interaction device 200 based on the determined status of the at least one driving assistance feature.

In an example, the human-computer interaction device 200 may comprises a communication module. For example, the human-computer interaction device 200 may communicate with a portable electronic device in the vehicle via the communication module. It is thus possible to receive a message from the portable electronic device and notify the user of this message on the human-computer interaction device 200. For example, the human-computer interaction device 200 may also interact with objects outside the vehicle. In addition to receiving messages from portable electronic devices inside the vehicle, the human-computer interaction device 200 may receive messages from outside the vehicle directly via satellite or cellular networks. Notifications to the user of these messages from inside and/or outside the vehicle may be scheduled via the human-computer interaction device 200 described above.

Aspects of the present disclosure also provides a vehicle equipped with the human-computer interaction device 200 as described above. The vehicle of the present disclosure may comprise but are not limited to: a car, a truck, a pickup, a two-wheeled motor vehicle, a three-wheeled motor vehicle, a motorcycle, a tank and other vehicles that travel on land, vehicles that travel off the surface of the earth such as airplanes, helicopters, spaceships, etc., and vehicles that travel on or under the water, such as ships, boats, yachts, and submarines.

Aspects of the present disclosure also provides a server device. The server may be a computing device for providing services and can provide services on electronic devices via a network. For example, the server may provide services comprising messages to the user via APPs installed by the user on other electronic devices. Notifications of messages from the server device may be scheduled for example on the electronic device. The electronic device may schedule notification of the message on the electronic device based on information contained in the message, from the server, related to notification scheduling.

FIG. 3 is a schematic diagram illustrating a server device 300 according to an example of the present disclosure. As shown in FIG. 3, the server device 300 may be configured to: obtain information S corresponding to the status of the at least one driving assistance feature of the vehicle via the network 303, and send information M corresponding to the message to be scheduled to the electronic device 310 based on the status of the at least one driving assistance feature of the vehicle. As illustrated in FIG. 3, the server device 300 may further comprises a memory 301 and a processor 302, where the memory 301 stores instructions that, when executed by the processor 302, cause the processor to perform the above steps.

In an example, the server device 300 may be coupled to both the electronic device 310 and the vehicle respectively and obtain information indicative of the statues of the at least one driving assistance feature of the vehicle directly from the vehicle.

In an example, the server device 300 may also be coupled only to electronic device 310 and not directly be coupled to the vehicle. Accordingly, the electronic device 310 may receive information corresponding to the status of the at least one driving assistance feature of the vehicle from an element of the vehicle associated with the at least one driving assistance feature and, as functioning as a relay station, forward the information to the server device 300.

The server device 300, upon receiving information corresponding to the status of the at least one driving assistance feature of the vehicle, may generate information corresponding to the message shall be scheduled.

In an example, the information corresponding to a message to be scheduled may comprise both message content and a notification scheduling indicator. For example, the processor of the server device 300 may include the notification schedule indicator into a field of the message and send the message containing the notification schedule indicator to the electronic device. For example, the notification scheduling indicator may indicate how the electronic device 310 should schedule the notification of the message.

In an example, when a notification of a message to a user is scheduled on a device (e.g., portable electronic device 110, human-computer interaction device 200, and/or server device 300 as described above), the screen of the device may be kept on (i.e., not turn off). The information displayed on the screen is therefore available to the user even during absolute manual driving.

In addition, the APP on the device can be kept running and the user is allowed to interact with the functions on the device via the screen. Moreover, in addition to the functions related to message notification (for example, the vibration module, the message visual module and the sound module of the device) stated in the present disclosure, any other functions on the device can remain in the status before the status of at least one driving assistance feature is changed.

Therefore, while the scheduling function is active, the user may not be disturbed by non-user-initiated message events, but interactions initiated by the user himself/herself may be available to the user, such as inputting functions of navigation and social applications. Therefore, the scheduling function of message notifications provided by the present disclosure can protect the user from being disturbed by non-user-initiated message events when, for example, changing from autonomous or semi-autonomous driving to manual driving, without limiting any spontaneous actions of the user.

In an example, user input to a trigger mechanism that receives a trigger from a user to change the statues of the at least one driving assistance feature may be interpreted as different trigger gestures based on the user's input operation. Different triggering gestures may correspond to different scheduling modes. That is, a trigger that changes the status of the at least one driving assistance feature may be arranged as a message scheduling mode selector for enabling the user to select a desired scheduling solution from various of predefined notification scheduling solutions.

The different scheduling modes may comprise a first scheduling and a second scheduling. For example, if the user, when changing the status of the at least one driving assistance feature, uses a first gesture for triggering the trigger mechanism, a first scheduling mode may be activated, and accordingly, message events may be scheduled as not notifying the user of the message events. Similarly, if the user, when changing the status of the at least one driving assistance feature, uses a second gesture for triggering the trigger mechanism, a second scheduling mode may be activated, and accordingly, message events may be scheduled as notifying the user of the message events.

In addition, the gestures may also comprise more than two gestures, and accordingly, the corresponding scheduling policy may comprise more than two policies. Different scheduling policies corresponding to different gestures may differ in the specific type of the messages notifying to the user from multiple different types of messages, while blocking/or deferring other types of messages. Furthermore, different scheduling policies corresponding to different gestures may differ in the group combined from various elements (sound, light and vibration) for notifying the use of the message (comprising one element or zero element).

Therefore, the example provides the user with such a scheduling policy that, the user may coherently and simply operate to select whether to change the scheduling policy of message notifications and/or to select the scheduling policy of message notifications from different scheduling policy s on the same trigger mechanism when the user changes the status of the driving assistance feature. This allows the user to select a desired scheduling strategy from different message scheduling strategies quickly and securely while driving the vehicle, this is because complex self-definition (e.g., through deep menus of the system) may be avoided. In other words, the user can achieve two aspects through basically one triggering action: (1) selecting or canceling the driving assistance feature; (2) choosing how to schedule message notifications during activation or deactivation of the driving assistance feature.

Any trigger mechanism capable of changing the status of the at least one driving assistance feature may be the trigger mechanism of the present disclosure. For example, the trigger mechanism may correspond to a button (comprising but not limited to a virtual button and/or a physical button) that activates and/or deactivates at least one driving assistance feature. For example, the trigger mechanism may also comprises steering wheel, turn signal bar, acceleration controller, deceleration controller, etc., because the user's operations on them can exit specific driving assistance features.

Different triggering gestures can differ in any aspect. For example, one triggering of the trigger mechanism within a predetermined relatively short period of time corresponds to the first triggering gesture, and two triggerings of the trigger mechanism within a predetermined relatively short period of time correspond to the second triggering. For example, a first trigger gesture may correspond to triggering the trigger mechanism for a first length of time, and a second trigger gesture may correspond to triggering the trigger mechanism for a second length of time. For example, a first triggering gesture may correspond to triggering the trigger mechanism with a first amount of force, while a second triggering gesture may correspond to triggering the trigger mechanism with a second amount of force.

According to an example, the device may determine the status of at least one driving assistance feature of the vehicle by determining (e.g., in an estimated manner) via a plurality of parameters from outside. Different driving assistance features may be provided by different suppliers, and there may be a lack of uniform indicators indicating the status of the driving assistance features. Therefore, the device can be configured with an estimation function for estimating the status of at least one driving assistance feature. The device may then schedule notification of the message to the user based on the estimated status of the driving assistance feature.

Alternatively, the driving assistance system may generate indication information indicating the driving assistance function status. The device according to the present disclosure may receive the indication information from the driving assistance system and determine the status of at least one driving assistance feature. The indication information may comprise data segments.

In an example, the data segments functioning as the indication information may comprise a valid data segment that is encoded to represent at least one driving assistance enabled state. The valid data segment may be interpreted at the device for use in determining a schedule to be executed later for notification of messages.

In an example, the data segment may further comprise a verification data segment, which may be used as a key. After receiving the data segment, the device interprets the data according to the predefined encryption specifications and determines whether it is the genuine indication information. After verifying that the indication information is true, the device may perform the scheduling of message notifications corresponding to the status of the driving assistance feature represented by the valid data segment in the indication information. On the contrary, if the verification of the indication information fails, the scheduling of the message notification may not be performed.

Note that, any encryption/decryption solution can be used for the examples associated with validating data segments. The above examples of the present disclosure are intended to implement security features of the scheduling of message notifications without necessarily specifying specific implementations of how to implement data validation.

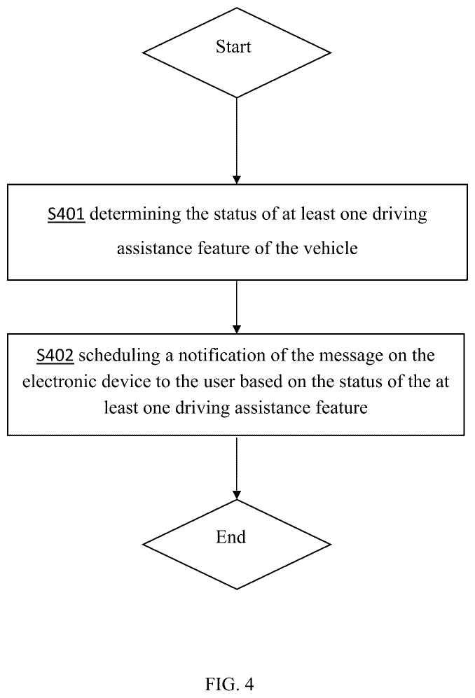

FIG. 4 illustrates a method 400 according to an example of the present disclosure. As illustrated in FIG. 4, the method 400 may comprises: S401 determining the status of at least one driving assistance feature of the vehicle; and S402 scheduling a notification of the message on the electronic device to the user based on the status of the at least one driving assistance feature.

The status of the driving assistance feature may comprise one or more of: a specific driving assistance feature being activated, deactivated, temporarily deactivated, or temporarily activated.

In an example, manual operations (or “interventions”) from a user, such as during operation of a specific driving assistance feature, may be detected. The manual operation from the user may comprises a user's operation input to one or more of, for example, a steering mechanism (e.g., a steering wheel), an accelerating mechanism (e.g., an accelerator pedal), and a deceleration mechanism (e.g., a deceleration pedal). Certain driving assistance features may, in response to manual user input, withdraw control of the movement of the vehicle (e.g., temporarily or permanently deactivate the driving assistance feature). Therefore, the status of the at least one driving assistance feature may comprises a temporary deactivation of the driving assistance feature in response to a manual operation by the user. This status may be terminated when the user ceases manual operation of the vehicle, and then the driving assistance feature that previously worked may autonomously take over the vehicle, i.e., be autonomously reactivated. For example, a previously active driving assistance feature may be caused to activate autonomously in response to detection that the user has ceased manual operation of the vehicle. In addition, the driving assistance features that previously worked can be reactivated in response to the user's trigger operation on the trigger mechanism.

The notification of message may comprise one or more of light notification, sound notification and vibration notification. The scheduling may refer to how one or more of the message notifications are sent to the user.

In an example, a user's manual operation on the movement of the vehicle during operation of at least one driving assistance feature may be detected, and in response to detecting the user's manual operation, a message on the electronic device may be scheduled as postponing or canceling the sending of the notification to the user. Additionally, message notifications that were scheduled not to be sent to the user during the user's manual intervention may be resent to the user in response to reactivation of the driving assistance feature that previously worked.

At least one driving assistance feature may comprises a plurality of driving assistance features providing different assistance operations (i.e., a plurality of driving assistance features at different levels). For example, the at least one driving assistance feature may comprises a first driving assistance feature and a second driving assistance feature, wherein the second driving assistance feature may provide more assistance operations than the first driving assistance feature. Scheduling the message notification comprises notifying the user of the notification of the message that is scheduled during activation of the first driving assistance feature, in response to the vehicle changing from activating the first driving assistance feature to activating the second driving assistance feature. For example, at least one of the light notification, sound notification, and vibration notification may be scheduled not to be sent to the user during the operation of the first driving assistance feature, and then can be sent to the user when the first driving assistance feature is changed to the second driving assistance feature. For example, a same message may correspond to multiple message notifications (for example, may correspond to a light notification and a sound notification), one notification may be sent to the user during the operation of the first driving assistance feature, and the other notifications may be scheduled as not to be sent to the user until the operation on the vehicle is changed from the first driving assistance feature to the second driving assistance feature. In other words, message notifications corresponding to the same message can be sent to the user in steps as the driving assistance feature changes.

In an example, the first driving assistance feature may be a function that can only control speed, that is, a function that can exempt the driver from the operation of acceleration and deceleration (for example, can control the vehicle to travel at a constant speed and/or control the vehicle to drive and/or slows down following a front vehicle). The second driving assistance feature can, in addition to controlling the speed, also assist the driver in controlling the driving direction of the vehicle (for example, changing the driving direction along the extending direction of the road, changing lanes, turning, etc.).

It should be noted that the above description of the first and second driving assistance features is only exemplary, and the difference between the first and second driving assistance features should not be limited to acceleration, deceleration and/or driving direction control. That is to say, the naming of the first driving assistance feature and the second driving assistance feature is not limited to functions that provide specific assistance operations. Rather, if one driving assistance feature can provide more assistance operations than another driving assistance feature, then the “one driving assistance feature” can be called as the first driving assistance feature, and the “another driving assistance feature” can be called as the second driving assistance feature. For example, the first driving assistance feature or the second driving assistance may be one of the following (but is not limited to the following): 0 assistance function (i.e., no assistance operation is provided); maintaining the speed of the vehicle; controlling the speed of the vehicle to change following the front vehicle; on closed roads where pedestrians and vehicles are separated, controlling, in addition to the speed, the travel direction of the vehicle; on open streets where there is no separation between pedestrians and vehicles, controlling, in addition to the speed, the travel direction of the vehicle to assist in changing the travel lanes and routes; recognizing and responding to traffic lights and stop signs.

In an example, the schedule comprises different levels of notification schedules, and wherein a higher level of notification schedule corresponds to the first driving assistance feature being activated, and a lower level of notification schedule corresponds to the second driving assistance feature being activated. In other words, multiple schedules may be predetermined and message notifications may be scheduled differently in response to the vehicle operating with different driving assistance features. The schedule may comprise a first level of notification scheduling and a second level of notification scheduling that is higher than the first level of scheduling, wherein the second level of scheduling may be less likely to attract the user's attention than the first level of scheduling. For example, in the case where the message notification comprises the light notification, sound notification and vibration notification, the first level of scheduling may comprise deferring and/or blocking one of the light notification, sound notification, and vibration notification, while the second level of scheduling may comprise delaying and/or blocking two of the light notification, sound notification and vibration notification.

As those skilled in the art can understand, scheduling is not limited to the first level of scheduling and the second level of scheduling illustrated above. The so-called “first level of scheduling” and “second level of scheduling” are only to distinguish the possibility that they can attract the user's attention. Scheduling may also comprise postponing and/or blocking “0” or all of the light notifications, sound notifications and vibration notifications. In addition, different levels of scheduling can also differ with respect to the degree of notification of a same message. For example, lower level of scheduling may produce stronger light, and/or greater volume, and/or greater amplitude vibrations relative to higher level of scheduling. For example, the duration of message notifications for lower level of schedule can be longer than for higher level of schedule. Therefore, as long as one schedule makes a message less likely to attract the user's attention relative to another schedule, then the “one schedule” can be called as the higher level of schedule or the second level of notification schedule, and the “other schedule” can be called as the higher-level of schedule or the second level of notification schedule.

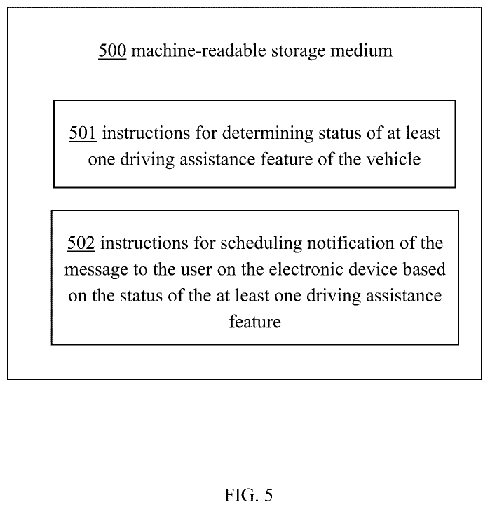

FIG. 5 illustrates a machine-readable storage medium 500 according to an example of the present disclosure. As shown in FIG. 5, the machine-readable storage medium 500 may store at least: instructions 501 for determining status of at least one driving assistance feature of the vehicle; and instructions 502 for scheduling notification of the message to the user on the electronic device based on the status of the at least one driving assistance feature.

Examples/embodiments described in accordance with any aspect of the present disclosure, and examples/embodiments described generally without explicitly applying the aspect description, may be combined with each other so long as they do not conflict under the description herein. For example, the methods of the present disclosure may comprise examples described with reference to the operation of the device of the present disclosure. Devices of the present disclosure may comprise examples described in terms of steps of methods of the present disclosure. Similarly, the readable storage medium 500 may also comprise any of the examples described with reference to the devices or methods of the present disclosure. For simple and convenient, not all examples of any combination are described in detail.

In this disclosure, such as “a” and “an” does not exclude the plural and examples or embodiments “an example” of the present disclosure may comprise multiple sub-examples based on the example.

Those skilled in the art will appreciate that various modifications, changes, omissions and substitutions may be made without departing from the spirit of the present disclosure and are not limited to the methods, apparatuses and methods that have been described with reference to the specific examples/examples/drawings and related aspects. Furthermore, those skilled in the art will be able to design many alternative embodiments without departing from the scope of the appended claims.

1. A portable electronic device, comprising:
a communication module which is able to communicatively coupled to a vehicle and to receive, from the vehicle, information associated with a status of at least one driving assistance feature of the vehicle; and
a processor, configured to being able to schedule a notification of a message to a user on the portable electronic device based on the status of the at least one driving assistance feature of the vehicle.

2. The portable electronic device of claim 1, comprising a scheduling mode, and wherein the processor is configured to, when the scheduling mode is activated, schedule the notification of the message based on the received status of the at least one driving assistance feature of the vehicle, and, in response to the scheduling mode being deactivated, notify the user of the message that were not notified to the user during the activation of the scheduling mode.

3. The portable electronic device of claim 2, configured to activate the scheduling mode in response to the portable electronic device being communicatively coupled to the vehicle and/or deactivate the scheduling mode in response to the portable electronic device being communicatively decoupled from the vehicle.

4. The portable electronic device of claim 2, wherein the scheduling mode corresponds to a driving-associated mode of the portable electronic device.

5. The portable electronic device of claim 1, wherein the processor is configured to perform different notification schedules for messages from different applications and/or for different types of messages.

6. A human-computer interaction device for installation on a vehicle, comprising:
a memory to store instructions;
a processor configured to, when executing the instructions, enable the human-computer interaction device to:
determine the status of at least one driving assistance feature of the vehicle; and
schedule a notification of a message to a user on the human-computer interaction device based on the status of the at least one driving assistance feature of the vehicle.

7. The human-computer interaction device according to claim 6, comprising: a communication module configured to receive messages at the human-computer interaction device from an object external to the human-computer interaction device, wherein the object external to the human-computer interaction device comprising a portable electronic device located inside the vehicle and/or an object external to the vehicle.

8. A vehicle comprising the human-computer interaction device according to claim 6.

9. A method for scheduling a notification of message to a user, comprising:
determining a status of at least one driving assistance feature of a vehicle; and
scheduling a notification to a user of a message on the portable electronic device based on the status of the at least one driving assistance feature.

10. The method of claim 9, further comprising: detecting a manual operation of the user to the movement of the vehicle during the operation of the at least one driving assistance feature, and causing the at least one driving assistance feature to release the operation to the movement of the vehicle in response to the manual operation, and the scheduling comprising scheduling, in response to the release, at least one message notification on the electronic device to be postponed to be sent to the user or to be canceled.

11. The method of claim 9, wherein the at least one driving assistance feature comprise at least a first driving assistance feature and a second driving assistance feature that provides more assistance operations than the first driving assistance feature, and wherein, scheduling the notification comprises: in response to the vehicle changing from activating the first driving assistance feature to activating the second driving assistance feature, notifying the user with a message that is scheduled during the activation of the first driving assistance feature.

12. The method of claim 9, wherein the at least one driving assistance feature comprise at least a first driving assistance feature and a second driving assistance feature that provides more assistance operations than the first driving assistance feature, and wherein, the scheduling comprise different levels of notification schedules, and wherein a higher level notification schedule corresponds to the activation of the first driving assistance feature, and a lower level notification schedule corresponds to the activation of the second driving assistance feature.

13. The method of claim 9, wherein the notification comprises generating one or more of sound, light, and vibration, and the scheduling comprises postponing the generation of one of the sound, light and vibration on the electronic device.
